(19) United States
(12) Patent Application Publication
(10) Pub. No.: US 2017/0186118 A1
(43) Pub. Date: Jun. 29, 2017

(54) METHOD, COMPUTER-READABLE STORAGE DEVICE AND APPARATUS FOR LOCATING AN OWNER OF AN ITEM

(71) Applicant: AT&T Intellectual Property I, L.P., Atlanta, GA (US)

(72) Inventor: Venson Shaw, Kirkland, WA (US)

(21) Appl. No.: 14/981,682

(22) Filed: Dec. 28, 2015

(51) Int. Cl. G06Q 50/18; G06Q 50/00; G06Q 30/02; G06Q 20/40

(52) U.S. Cl. CPC G06Q 50/188; G06Q 20/405; G06Q 50/01; G06Q 30/0261

(57) ABSTRACT

Methods, computer-readable storage media and apparatuses for locating the owner of an item on behalf of a user are disclosed. A processor receives over a communication network associated with the network service provider, from an endpoint device of a buyer, an offer for an item of interest that is not for sale, receives an image of the item of interest, receives location information associated with the item of interest, determines an identity of an owner of the item of interest using the image and the location information, sends over the communication network associated with the network service provider, the offer to an endpoint device of the owner of the item of interest, receives over the communication network associated with the network service provider, a response to the offer and sends over the communication network associated with the network service provider, the response to the endpoint device of the buyer.

The present disclosure relates generally to communication networks and, more particularly, to methods, computer-readable storage devices and apparatuses for locating the owner of an item on behalf of a user.

### BACKGROUND

Consumers are becoming ever more willing to seek out unique items for purchase. For example, consumers may want to purchase unique items that the consumers may encounter while traveling, e.g., walking down the street or driving through a neighborhood. Upon seeing an item of interest, the user may want to make an offer for the item. However, it is often difficult to ascertain the owner of the item of interest.

### SUMMARY

In one example, the present disclosure discloses methods, computer-readable storage media and apparatuses for locating the owner of an item on behalf of a user. A processor receives over a communication network associated with the network service provider, from an endpoint device of a buyer, an offer for an item of interest that is not for sale, receives an image of the item of interest, receives location information associated with the item of interest, determines an identity of an owner of the item of interest using the image and the location information, sends over the communication network associated with the network service provider, the offer to an endpoint device of the owner of the item of interest, receives over the communication network associated with the network service provider, a response to the offer and sends over the communication network associated with the network service provider, the response to the endpoint device of the buyer.

### BRIEF DESCRIPTION OF THE DRAWINGS

The teaching of the present disclosure can be readily understood by considering the following detailed description in conjunction with the accompanying drawings, in which:

FIG. 1 illustrates an example network related to the present disclosure;

FIG. 2 illustrates example physical environment in which a user may encounter an item of interest;

FIG. 3 illustrates an example user interface for allowing a user to present an offer for an item of interest;

FIG. 4 illustrates a flowchart of an example method for presenting an offer for an item of interest in accordance with the present disclosure;

FIG. 5 illustrates a flowchart of an example method for processing an offer for an item of interest in accordance with the present disclosure; and

FIG. 6 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable media and devices for locating the owner of an item on behalf of a user. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one example, the present disclosure provides a transaction service for locating the owner of an item of interest on behalf of a user. Locating the owner or seller of an item is often not an issue since items that are for sale are often presented by a retailer or an owner via well-defined channels of commerce, e.g., via a brick and mortar store, an online web site, a printed advertisement, and so on. However, if a user is interested in an item that is currently not for sale, i.e., the owner of the item has not provided any indication that the item is for sale, then it may be difficult to locate the true owner of the item.

To illustrate, if a user is walking down a street and sees a statue in a public place, it is presumed that the statue is not for sale. In one scenario, the statue is owned by the city where the statue is being displayed for the enjoyment of the city's residents. In another scenario, the artist of the statue is given permission by the city to display the artist's works throughout the city on a temporary basis, but the artist's works may still not be for sale. In still another scenario, the statue is an advertising prop deployed by a retailer to promote the business of the retailer, but the advertising prop itself is not for sale. In still yet another scenario, the statue is privately owned by an individual and is being displayed outside of the owner's home (e.g., a residential property) to improve the aesthetics of the owner's home, but again, the item is not for sale.

To illustrate another example of items that are not for sale, a city may own various infrastructural items that are not for sale to the general public, since such items are functional and not decorative in nature. For example, a city, a government agency, or a commercial business may own and operate various infrastructures such as street lights, traffic lights, telephone booths, traffic signs, street signs, mail boxes, public pay phones, hydrants, public tables and benches, and the like.

Nevertheless, items that are not for sale may still be items of interest to different individuals. Since such items are not for sale to begin with, a potential buyer has no easy means to present an offer. More specifically, it is often the case that the buyer does not even know the true owner of such items that are not for sale. Thus, presenting an offer by the buyer to an unknown owner is quite difficult.

The above list of examples of items not for sale is only illustrative and not exhaustive. It is noted that vast number of items are not for sale under numerous different scenarios. It is contemplated that any of these different scenarios will benefit from the methods of the present disclosure.

In one embodiment of the present disclosure, a transaction service is provided by a network service provider to receive an offer from a buyer for an item of interest that is currently not for sale. One aspect of the transaction service is to locate the proper owner of the item of interest on behalf of the buyer. In the present disclosure, the term “an item not for sale” is intended to cover any item that is not presented on a commerce channel where the item is currently being offered to be purchased. Furthermore, the present transaction service is not intended to cover a searching service where the searching service locates a general item sought after by a buyer. In other words, the present transaction service is not intended to receive a search request where a buyer simply presents a generic request for a seeking an item, e.g., “looking for a 1966 Ford mustang in good condition.” In contrast, the present transaction service is intended to cover a particular item specifically identified by the buyer, e.g., via a pictorial identification (e.g., presenting a picture of the item of interest).

Another aspect of the present disclosure, is that the network service provider serves as an intermediary between the buyer and the owner of the item of interest. For example, a buyer may be walking down the street and sees a house that the buyer wants to buy. However, there is no indication that the owner of the house is even offering the house for sale. Furthermore, it may not be clear to the buyer whether the owner is currently occupying the house or whether the current tenants are renters of the house. Furthermore, the owners may not want to be disturbed by the buyer (e.g., a stranger) reaching out directly to them with an unsolicited offer by direct contact, e.g., ringing their door bell and the like. Similarly, it may be awkward for the buyer to initiate such direct contact given that the item of interest is not even for sale at the present time. As such, a buyer may be weary of presenting an offer and the necessary private contact information to a stranger who may have no intention of ever entertaining the sale of the item of interest. Thus, the network service provider serving as an intermediary between the buyer and the owner of the item of interest is able to help maintain the anonymity of the transacting parties until the transaction reaches a certain point where consummation of the sale is likely.

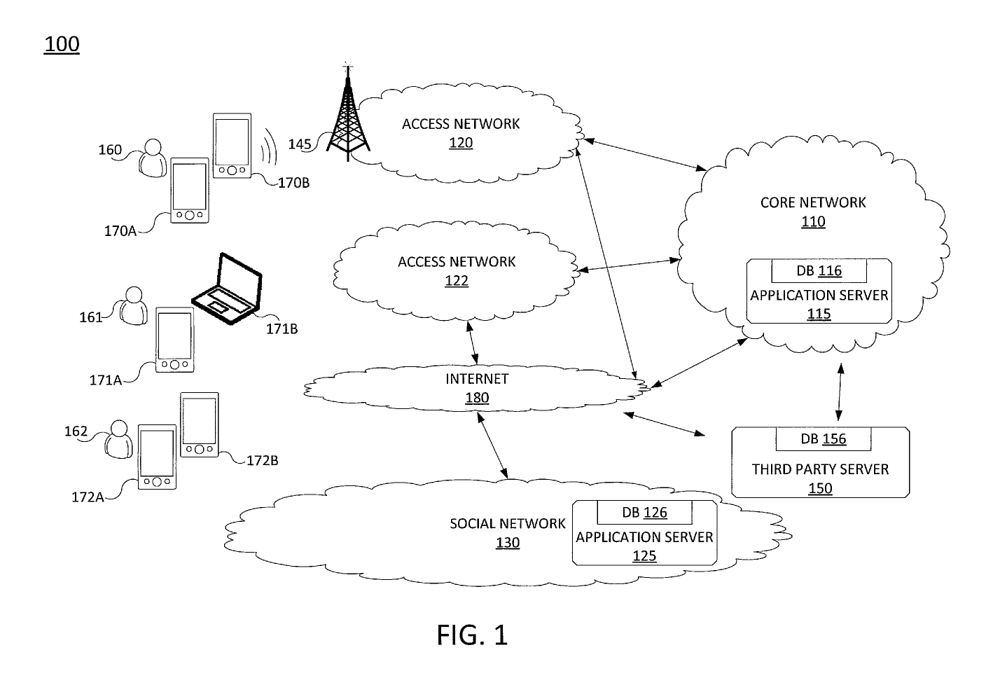

To aid in understanding the present disclosure, FIG. 1 illustrates a block diagram depicting one example of a communication network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and so forth. It should be noted that an IP network is broadly defined as a network that uses Internet Protocol to exchange data packets.

As shown in FIG. 1, the communication network 100 connects endpoint devices 170A-172A and 170B-172B with each other and/or with one or more application servers via a core network 110, access networks 120 and 122, social network 130 and/or Internet 180. In one embodiment, core network 110, e.g., an IP network, interfaces with one or more of the access networks 120 and 122, and may also include interfaces to the Internet 180 and/or social network 130. Access network 120 may comprise a wireless access network (e.g., an IEEE 802.11/Wireless-Fidelity (Wi-Fi) network and the like) or a cellular access network, and may include a cellular base station and/or wireless access point 145. In one embodiment, access network 122 may comprise a PSTN access network, a cable access network, a wired access network and the like. In one embodiment, the access networks 120 and 122 and the core network 110 may be operated by different service providers, the same service provider or a combination thereof. Various interconnections between access networks 120 and 122, core network 110, Internet 180 and social network 130 are shown. In accordance with the present disclosure, it is contemplated that devices may utilize any one or a combination of such networks and interfaces in order to communicate with one another.

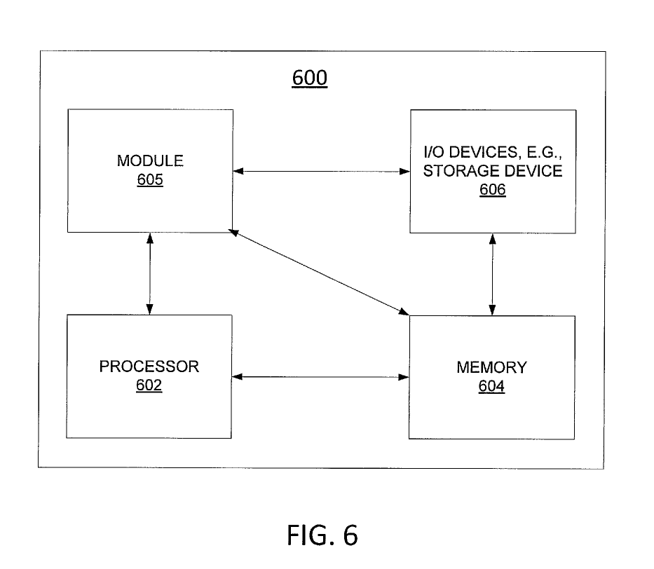

In one embodiment, the core network 110 may include an application server (AS) 115, e.g., a dedicated database server and a database (DB) 116. Although only a single AS 115 and a single DB 116 are illustrated, it should be noted that any number of application servers 115 or databases 116 may be deployed. In one embodiment, the AS 115 may comprise a programmed computing device as illustrated in FIG. 6 and discussed below. In one embodiment, the AS 115 is configured to perform steps, functions and/or operations of a transaction service, e.g., for locating the owner of an item on behalf of a user, accordance with the present disclosure. As such, DB 116 may store program code, data, files, and so forth to enable such functions. Thus, various embodiments are described herein as residing in or being performed in whole or in part by AS 115. For instance, AS 115 may receive an offer for an item of interest where the item is not for sale. The offer is accompanied by an image of the item of interest and location information relating to the captured image of the item of interest. Using the captured image and the location information, the AS 115 will attempt to locate the owner of the item of interest on behalf of the users.

In one example, the DB 116 has one or more libraries of infrastructural items (broadly infrastructural information) for various jurisdictions, e.g., states, counties, municipalities, towns, and so on. In other words, the DB 116 may have access to databases operated and maintained by various governmental agencies, commercial entitles, or utility entities as to infrastructural items maintained by each of the governmental agencies, commercial entitles, or utility entities, e.g., street lights, traffic lights, telephone booths, traffic signs, street signs, mail boxes, public pay phones, hydrants, public tables and benches and the like. Furthermore, the DB 116 may have access to databases operated and maintained by various governmental agencies or commercial entities as to real estate property descriptions and their physical locations, e.g., a database of recorded deeds of real estate properties and the like. Furthermore, the DB 116 may have access to databases operated and maintained by various governmental agencies or commercial entities as to maps of geographical locations. For example, such online entities may employ vehicles with cameras to capture pictures of neighborhoods in which the vehicles have traversed.

Alternatively, the DB 116 need not have stored all of the above discussed sources of information. For example, AS 115 may interact with a third party server 150 (e.g., operated by each one of the governmental agencies, commercial entitles, or utility entities) to obtain the necessary information, e.g., the name of the owner of the item of interest and the owner's contact information.

In one embodiment, a captured image and the location information provided by the buyer can be used to identify the item of interest and its owner using DB 116. For example, if the captured image is of a house and the location information comprises global positioning system (GPS) coordinates and/or the street address of the house, then the present method will search the DB 116 to determine or confirm the address of the house and the recorded owner of the house. In another example, if the captured image is of a statue and the location information comprises global positioning system (GPS) coordinates and/or the street address of the house, then the present method will search the DB 116 to determine or confirm the owner of the statue, by checking images of all statues owned by one or more government agencies based on the location information. Similarly, all statues currently on exhibition within a particular jurisdiction will be consulted to determine the owner of the statue and so on.

Alternatively, the captured image and the location information can be forwarded to the third party server 150 having a DB 156. The network service provider may have a contractual arrangement with such third parties to identify the owner of the item of interest. For example, if the identified item is a phone booth, the network service provider may forward the captured image of the phone booth and the location information to a utility company, e.g., a local phone company, who is likely the operator of the phone booth. In turn, the local phone company may confirm that the captured image is consistent with a phone booth that it is currently operating at a location indicated by the location information. The local phone company may also provide the contact information of a manager who is in charge of managing the infrastructures of the local phone company including making any decisions as to the sale of any of its infrastructural items.

In one example, social network 130 may also include an application server (AS) 125 and a database (DB) 126, which may be the same or similar to AS 115 and DB 116 in the core network 110 and which are also suitable to perform at least the same functions. Similarly, in another embodiment one or more application servers (not shown), e.g., connected to Internet 180, may perform the same or similar functions. In other words, one or more application servers as deployed in a cloud environment may implement the functions as discussed herein. In other words, in one example, the social network service provider may provide the transaction service as discussed herein.

In one embodiment, each of endpoint devices 170A-172A and 170B-172B may comprise an endpoint device configured for wireless or wired communication such as a personal computer, a laptop computer, a Personal Digital Assistant (PDA), a mobile phone, a smart phone, an email device, a computing tablet, a messaging device, a computing pair of glasses, and the like. As illustrated in FIG. 1, endpoint devices 170A-172A and 170B-172B may belong to and/or be associated with users 160-162, respectively. In particular, each of users 160-162 may have multiple associated endpoint devices. For example, user 160 may have both a personal smart phone (e.g., endpoint device 170A) as well as a work smart phone assigned by an employer (e.g., endpoint device 170B). Similarly, user 161 may have both a mobile phone (e.g., endpoint device 171A) as well as a personal computer (e.g., endpoint device 170B). In addition, user 162 may also have a personal smart phone (e.g., endpoint device 172A) as well as a work smart phone assigned by an employer (e.g., endpoint device 172B).

Notably, one or more of the users 160-162 may be a subscriber of access network 120 and/or core network 110. In other words, the user is already a customer of the network service provider that provides one or more communication services such as cellular phone services, voice over IP services, long distance telephony services, Internet access services, data services, multimedia delivery services, and the like.

Accordingly, in one embodiment DB 116 of AS 115 in the core network 110 may store infrastructural information for various jurisdictions, e.g., states, counties, municipalities, towns, and so on. Again, infrastructural information broadly encompass information relating to real estate information (e.g., physical addresses of homes and businesses and their descriptions including an exterior picture of the homes or businesses) and/or infrastructures maintained and/or operated by each of the governmental agencies, commercial entitles, or utility entities.

In one embodiment, DB 116 of AS 115 in the core network 110 may also store privacy information of one or more of users 160-162, e.g., users who are also network subscribers and may potentially be buyers and/or owners of items of interest as further discussed below. Taking user 160 as an example, the privacy information stored in DB 116 may include a name, billing address, service address, telephone number and email address associated with user 160. The privacy information may also include geographic location information regarding user 160. For example, location information may be determined from a source IP address associated with communications from user 160, global positioning system (GPS) information of a mobile device of the user, serving base station information, and so forth. The privacy information stored in DB 116 may also comprise biographic information, e.g., age, memberships in various groups, professional associations, and so forth, as well as calendar information for the user 160. The privacy information may also include a contact list of the user 160 that may comprise various contacts in various categories including: friends, family, colleagues, sports team members, hobby group members, and so forth. Finally, the privacy information may also include consent information or data associated with how the privacy information can be used in analytics in response to third party business inquiries.

Application server (AS) 115 may also access and/or store in DB 116 call detail records (CDRs) derived from telephone calls, emails, text messages, instant messages, multimedia messages (MMS), VoIP application usage, and the like which traverse various networks including core network 110, access networks 120 and 122, and so forth. Such CDRs may be gathered and accessed using any techniques which are known in the art and may, be used for various purposes in accordance with the present disclosure, as described in greater detail below. Furthermore, AS 115 may also have access to various other services that the user may have subscribed to. For example, the user may also have one or more subscriptions to a multimedia content delivery service, e.g., requesting movies to be streamed to the user, an Internet access service, a data delivery service, a health wellness monitoring service, a financial planning service, a banking service, an online product purchase service, a home monitoring service, a home or business security service, a remote network access service and so on. It should be noted that the above list of subscribed services is only illustrative, but is not intended to be exhaustive.

In turn, Application server (AS) 115 may also access and/or store in DB 116 the consents as to the use of the user's privacy information in any one of the subscribed services. In other words, Application server (AS) 115 may serve as a centralized platform for storing the consents as to the use of the user's privacy information. This allows the Application server (AS) 115 to perform analytics on the user's privacy information as part of the privacy information management service provided to the user as further discussed below. Furthermore, Application server (AS) 115 may also enhance the user's data experience in terms of privacy information management as discussed below.

In addition, each of the users 160-162 may participate in social networking via social network 130. Thus, each of the users 160-162 may have a social network privacy information that includes: posts and messages of the user, biographic information of the user, information on contacts of the user and/or other participants of the social network with whom the user has interacted, location/check-in information of the user, and so forth. In one example, the social network privacy information of each of the users 160-162 may be stored in database (DB) 126 of application server (AS) 125. Collectively, the information stored in DB 126 may be referred to as social network information and may be used for supplementing the privacy information as stored by AS 115 in DB 116.

For instance, application server (AS) 115 may access the social network information from AS 125/DB 126 and use such information as an alternative to or in conjunction with stored privacy information in DB 116 and call detail record information available to AS 115 to automatically respond to an offer presented by a buyer. For example, the user may have certain subscription to services that are provided or identified via the social network, which may further have associated privacy information of the user. Such privacy information of the user can be extracted from the social network by AS 115 and stored in the DB 116 if consent is provided by the subscriber to perform such extraction, thereby saving user time in having to provide privacy information again to AS 115.

Alternatively, in one example privacy information of the user can be extracted from the core network by AS 125 and stored in the DB 126. In other words, the functions or operations of the present disclosure can be deployed in the AS 125 of the social network as well.

FIG. 1 also shows a third party server 150 with a DB 156, which may be operated by a third party entity (e.g., one or more governmental agencies, commercial entitles, or utility entities and so on). It should be noted that although only one third party server 150 is shown in FIG. 1 for clarity reasons, any number of third party servers can be represented in FIG. 1.

Furthermore, it should be noted that the network 100 has been simplified. For example, the network 100 may include other network elements (not shown) such as border elements, routers, switches, policy servers, security devices, gateways, a content distribution network (CDN), firewalls, and the like. Thus, FIG. 1 is only intended to illustrate one example environment in which embodiments of the present disclosure may be employed.

In one embodiment, the user provides privacy information to the communication network operated by the network service provider to be managed via a privacy information management service. Privacy information may comprise: 1) geo-location information, e.g., the current physical location of the user, 2) multimedia content consumption information, e.g., the type of content such as movies and/or programs watched and preferred by the user, 3) viewing schedule information, e.g., time schedule that the user is watching or prefers to watch the content, e.g., 9:00 pm on a Sunday and so on, 4) medication information, e.g., medication purchased by the user, 5) medical information, e.g., medical conditions associated with the user, medical services used by the user, e.g., hospitals and medical clinics, 6) delivery of product information, e.g., the time and day that a product is delivered to the user, 7) financial information, e.g., banking information, mortgage information, credit information, credit card information and the like, 8) biometric information, e.g., the current body temperature of the user, the current weight of the user, the current shoe size of the user, the current height of the user, and the like, 9) appointment information of the user, e.g., events on a calendar of the user, 10) communication information, e.g., individuals that the user has communicated with via phone calls, emails, text messages, the preferred modality of communication, e.g., texting, emails, cellular calls, and the like, 11) contact information, e.g., phone numbers of contacts (e.g., friends, family and co-workers), email addresses of contacts, home addresses of contacts, 12) lodging preferences (e.g., types of hotels, brand of hotel chains, types of rooms, smoking or non-smoking rooms, and so on), 13) traveling preferences (e.g., types of transportation mode (e.g., planes, trains, buses, or types of rental cars), brand of airlines, bus carriers, train carriers, types of seating, types of travel locations, types of landmarks to be visited when travelling, and so on), 14) eatery preferences (e.g., types of restaurants, types of food, types of spices to be applied to food, range of costs willing to be incurred for food and drink, locations of eateries), 15) entertainment preferences (e.g., types of sports, types of shows, types of movies, types of television programming, types of music), and so on. Again, this list of privacy information is only illustrative and should not be deemed to be an exhaustive list.

Given the need of the innate functionality of a user making various product purchases, a user may have to provide certain portions of the privacy information to be used by one or more business entities. For example, purchasing a product online may require the user to provide consent as to the use of: 1) the user's credit card information to complete the transaction, and 2) the user's email address to receive product delivery tracking information, e.g., a tracking number of a delivery service. In another example, purchasing a medical boot may require the user to provide consent as to the use of: 1) the user's medical records to ascertain the prescription for the purchase of the medical boot, and 2) the user's biometric information such as the size of the user's foot so that a properly sized medical boot can be determined. Such consents are often freely provided by the users since they pertain to the innate functionalities of the provided services.

However, the privacy information provided in the above examples need not be provided in an offer presented by the user for an item not for sale. In other words, at an early stage of the transaction, the buyer may not want to reveal any privacy information in such a speculative offer. In other words, since the item of interest is technically not for sale, the probability of the transaction being consummated is relatively low. As such, there is no need to disclose any of the privacy information to the owner of the item of interest. For example, the buyer's email address can be used to allow the owner to interact with the buyer. In another example, the buyer's credit card information or banking information can be used to determine whether the buyer is qualified or even capable of making the purchase and so on. As a result, although a buyer is willing to make known his or her interest in making an offer to the owner for an item that is not currently for sale, the buyer may not want to reveal any privacy information at the early onset of the transaction.

In one embodiment, the present disclosure provides a transaction service offered by a network service provider. For example, a user (e.g., a buyer) will provide privacy information to be stored on a communication network of the network service provider. For example, the privacy information can be manually provided to the network service provider, e.g., answering a survey with a plurality of questions. In another example, the privacy information can be automatically extracted by the network service provider, e.g., monitoring the user's commercial transaction activities (e.g., commercial transactions in procuring goods or services) over the communication network, monitoring the user's communication activities (e.g., email communications, text messaging activities, phone records, and the like), and so on. In other words, if the network service provider is providing Internet access service to the user, then the network service provider may monitor the transactions made by the user over the Internet. Similarly, if the network service provider is providing cellular service or data service to the user, then the network service provider may monitor the communication activities and transactions made by the user over the cellular service or data service. Any such automatic monitoring must be in accordance with receiving an affirmative consent by the user as part of the privacy information management service. This allows the user to consolidate his or her privacy information in one centralized platform. The network service provider is then tasked with performing a transaction service on behalf of the user, e.g., a buyer, in this context.

For example, a user has entered a municipal building and observed a painting hanging in the lobby of the municipal building. Although there is clearly no indication that the painting is for sale, the user is nevertheless interested in purchasing that particular painting, but is unable to determine: 1) the painting's owner and 2) the contact information for the owner of the painting. In accordance with the present disclosure, the user may simply take a picture of the painting (e.g., a captured image of the item of interest) and forward the captured image along with the location information, e.g., the location of the endpoint device taking the picture, with an offer to purchase the painting to the network service provider. In turn, it is now the task of the network service provider to determine the owner of the painting and send an inquiry to the owner to ascertain whether the painting is for sale on behalf of the user. If the owner is not interested, the owner's response is provided to the user without revealing the identities of both parties to each other. Thus, anonymity is maintained for both the buyer and seller. However, if the owner is interested in selling the item of interest, the network service provider will serve as a go-between for the buyer and the seller (e.g., assisting in the exchange of offers and counter offers). When the conclusion of the transaction is deemed to be imminent or pursuant to the consent of the buyer and seller, the network service provider may reveal the identities between the buyer and seller and any pertinent contact information in order for the buyer and seller to consummate the transaction.

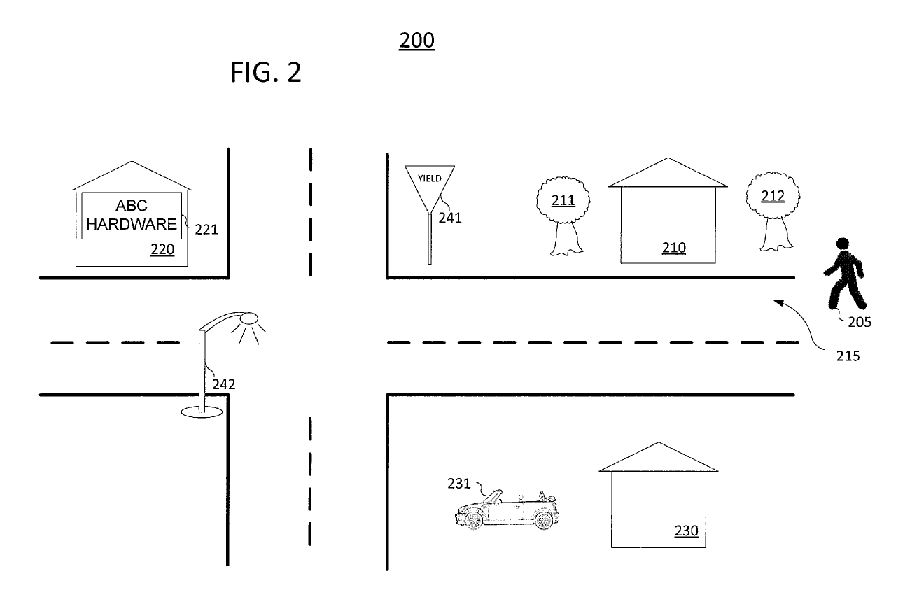

FIG. 2 illustrates an example physical environment 200 in which a user may encounter an item of interest. For instance, the environment 200 may comprise a plurality of homes, governmental and/or business establishments 210, 220, and 230. In one example, a residential property may comprise a house 210 and several exterior items 211 and 212, e.g., trees, shrubs or plants. In another example, a residential property may comprise a house 230 and an exterior item 231, e.g., a parked vehicle. In yet another example, a commercial property may comprise a store 220 and an exterior item 221, e.g., an advertising sign indicating the business of the store. Finally, the physical environment 200 also illustrates several infrastructural items such as a traffic sign 241 and a street light 242. It should be noted that any number of infrastructural items in public properties and residential and commercial properties can be illustrated in FIG. 2.

In one example, a user 205 (e.g., a buyer) may be traversing along a path 215. The user 205 may be interested in a particular item of interest, e.g., the plant 211. The user may then take a picture of the plant 211, e.g., using a mobile phone having a camera, and sending the captured image to the network service provider. The captured image is sent along with location information (e.g., GPS coordinates) of the mobile phone and an offer to purchase the plant 211, e.g., a cash offer of $150.00.

In another example, the user 205 may be interested in another particular item of interest, e.g., the vehicle 231. The user may then take a picture of the vehicle 231 and/or the license plate, e.g., using a mobile phone having a camera, and sending the captured image to the network service provider. The captured image is sent along with location information (e.g., GPS coordinates) of the mobile phone and an offer to purchase the vehicle 231, e.g., a cash offer of $20,000.00.

In yet another example, the user 205 may be interested in another particular item of interest, e.g., the advertising sign 221. The user may then take a picture of the advertising sign 221, e.g., using a mobile phone having a camera, and sending the captured image to the network service provider. The captured image is sent along with location information (e.g., GPS coordinates) of the mobile phone and an offer to purchase the advertising sign 221, e.g., a cash offer of $1,000.00.

In yet another example, the user 205 may be interested in another particular item of interest, e.g., the street sign 241. The user may then take a picture of the street sign 241, e.g., using a mobile phone having a camera, and sending the captured image to the network service provider. The captured image is sent along with location information (e.g., GSP coordinates) of the mobile phone and an offer to purchase the street sign 241, e.g., a cash offer of $1,500.00.

As the above examples illustrate, the item of interest is not currently for sale. In other words, the user 205 is simply interested in these items and is willing to send out an unsolicited offer to see whether the owner is willing to sell the item of interest. Thus, the present transaction service provides a service for locating an owner of an item of interest, and then to provide a forum, a conduit or a market place for such potential business transactions to be consummated.

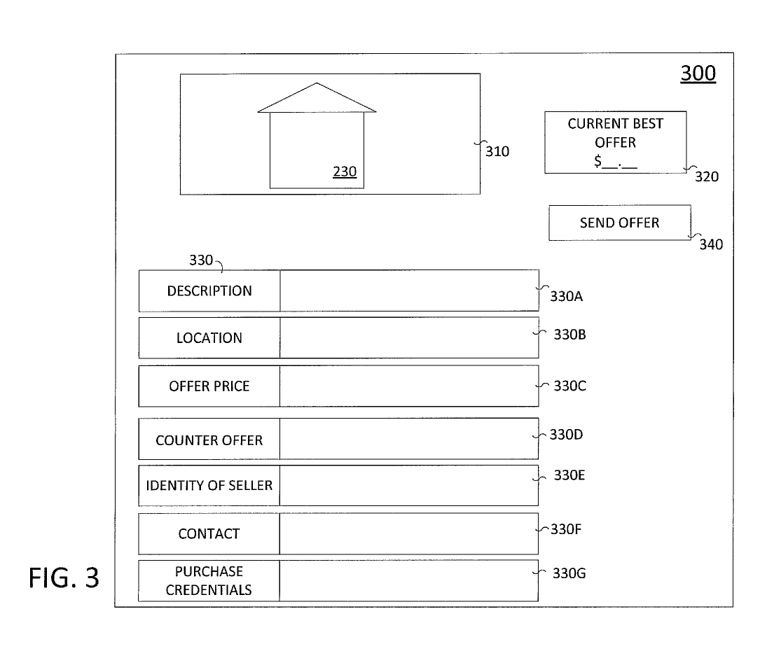

FIG. 3 illustrates an example user interface 300 for allowing a user to present an offer for an item of interest. In one embodiment, the user interface 300 comprises a display area 310 for showing a captured image of the item of interest and a plurality of transaction fields 330 (herein referred to individually as a transaction field 330 or collectively as transaction fields 330), e.g., a description field 330A, a location field 330B, an offer price field 330C, a counter offer price field 330D, an identity of seller (or owner) field 330E, a contact field 330F, and/or a purchase credentials field 330G.

In one example, after the user has captured the image of the item of interest, the user may provide one or more additional types of transaction information. For example, the user may enter a description of the item of interest in the description field 330A, e.g., “A brown Victorian house.” In another example, the user may enter a location of the item of interest in the description field 330B, e.g., “Located on 123 Main Street, ABC town, NJ, xxxxx.” In another example, the user may enter an offer price for the item of interest in the description field 330C, e.g., “I am offering $1,000 for the item X.” In another example, the user may receive a counter offer price for the item of interest in the description field 330D, e.g., “Sorry, Item X is worth $5,000.” In another example, the user may receive information pertaining to the identity of the seller (or owner) for the item of interest in the description field 330E, e.g., “My name is John Doe and I am the owner of the house.” In another example, the user may receive information pertaining to the contact information of the seller (or owner) for the item of interest in the description field 330F, e.g., “You can call me at (111) 111-1111 to discuss your offer.” In another example, the user may enter purchase credential information for the item of interest in the description field 330G, e.g., credit card information, banking information, pre-approved mortgage information, credit report score, and the like.

In one example, once the pertinent transaction fields are populated, the user may engage a button or field 340 to send the offer along with the captured image and the location information to the network service provider for processing. In one example, a field 320 is used to track the current best offer made for the item of interest, e.g., the field will reflect the latest offer sent to the seller. In one embodiment, the latest offer sent to the seller may not be an offer sent by the user. For example, if multiple users are vying for the same item of interest, then field 320 will show the most recent offered price. If the seller receives the first offer from the user for the item of interest, the seller may suddenly realize that there is an interest in one of his or her item that was initially not for sale. However, once convinced that the item is now available for sale, the seller may present the item of interest for sale to several individuals, e.g., inducing bidding among the interested users. The field 320 allows the price bidding to be easily tracked and disclosed back to all of the users interested in bidding for the item of interest.

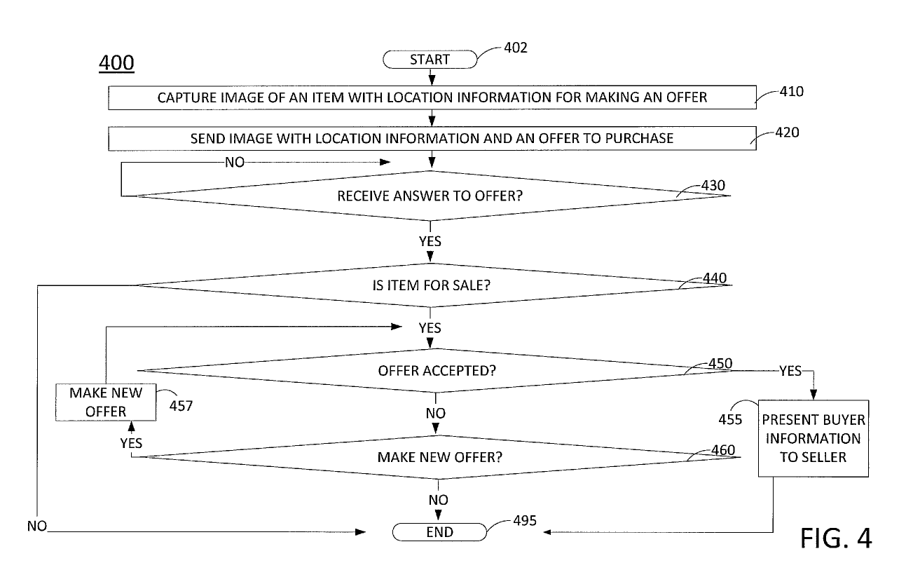

FIG. 4 illustrates a flowchart of an example method 400 for presenting an offer for an item of interest in accordance with the present disclosure. In one embodiment, steps, functions and/or operations of the method 400 may be performed by a user endpoint device, e.g., endpoint device 170A or 170B in FIG. 1, or by a network-based device in conjunction with a user endpoint device. In one embodiment, the steps, functions, or operations of method 400 may be performed by a computing device or system 600, and/or processor 602 as described in connection with FIG. 6 below. For illustrative purpose, the method 400 is described in greater detail below in connection with an embodiment performed by a processor, such as processor 602. The method begins in step 402 and proceeds to step 410.

At step 410, the processor captures an image of an item of interest e.g., via an optical sensor or a camera of a mobile endpoint device. In one example, the location information when the image is captured is also noted in the mobile endpoint device, e.g., the GPS coordinates of the mobile endpoint device when the image was taken. In one embodiment, the location information may include additional information, e.g., the processor may receive manual input from the user or from a map application loaded on the mobile endpoint device, e.g., a current street address where the image was taken. Thus, in one embodiment, location information may comprise coordinate location information and/or street address information.

At step 420, the processor sends the image with the location information and an offer to purchase the item of interest to the network service provider, e.g., to AS 115, which is specifically configured to process such offers as a subscribed service. The offer comprises a dollar amount for purchasing the item of interest. For example, if the item of interest is a house, then the offer may be $300,000.

At step 430, the processor determines whether an answer responsive to the offer is received. If the query is answered negatively, the method 400 returns to step 430. If the query is answered positively, the method 400 proceeds to step 440.

At step 440, the processor determines whether the answer indicates the item is for sale responsive to the offer. If the query is answered negatively, the method 400 ends in step 495. If the query is answered positively, the method 400 proceeds to step 450.

At step 450, the processor determines whether the offer is accepted. If the query is answered negatively, the method 400 proceeds to step 460. If the query is answered positively, the method 400 proceeds to step 455.

At step 455, the processor presents the buyer information to the seller to start the process of consummating the transaction. In other words, the buyer authorizes the network service provider to reveal pertinent buyer privacy information (e.g., name of the number, address of the buyer, contact information of the buyer (e.g., a cellular phone number), credit card information of the buyer, pre-approved qualification of the buyer and so on), to the seller. In one embodiment, the identity and the privacy information of the buyer are not initially presented to the seller. This allows the initial negotiation to be conducted with a certain amount of anonymity of both the seller and the buyer. However, in certain situations, a seller may want more information to ensure that the negotiation is not conducted in vain, e.g., the seller may want the buyer to reveal certain privacy information early on before the negotiation is conducted. For example, a seller of a home may want to ensure that the unsolicited offer is a real offer and not a prank. As such, the seller may demand to have a verification that the buyer is prequalified for the amount of $300,000 as a mortgage loan before conducting any in depth negotiation with the buyer. As such, step 455 may occur much sooner and should not be limited as a step to be performed only after the offer is accepted. For example, step 455 may be implemented after step 440 once the item is deemed to be available for purchase.

At step 460, the processor determines whether to make a new offer. For example, the response from the seller may be a simple no response without a counter offer in rejecting the offer or the response may further comprise a counter offer. If the user does not want to make another offer, the method ends in step 495. If the user does want to make another offer, the method proceeds to step 457, where another offer is made, e.g., adding another $5,000 to the original offer. The method then returns to step 450. The method then ends when a final offer is accepted or when the buyer no longer wants to make another offer.

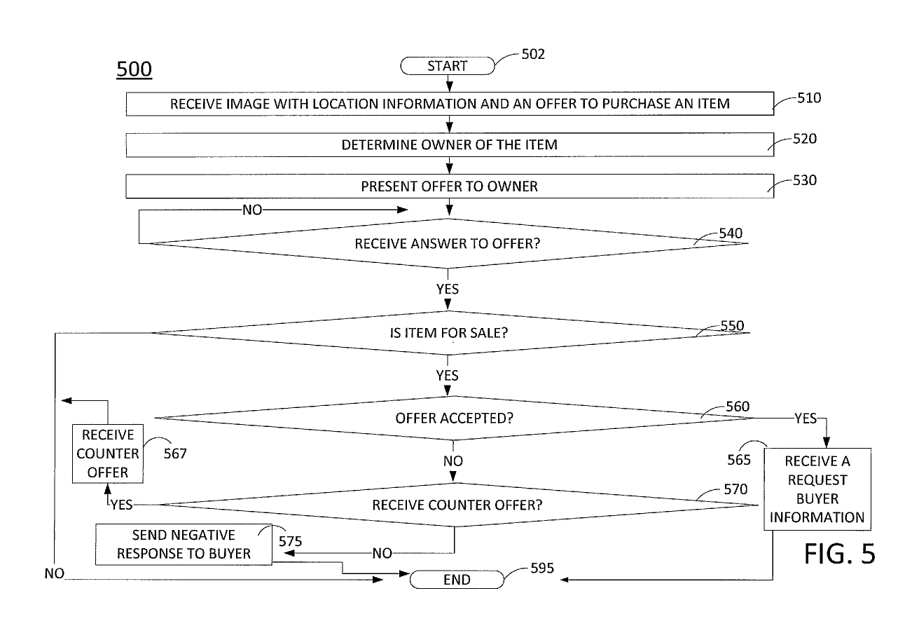

FIG. 5 illustrates a flowchart of an example method 500 for processing an offer for an item of interest in accordance with the present disclosure in accordance with the present disclosure. In one embodiment, steps, functions and/or operations of the method 500 may be performed by a network-based device, e.g., application server 115 or application server 125, in FIG. 1. In another embodiment, steps, functions and/or operations of the method 500 may be performed by a user endpoint device, e.g., endpoint device 170A or 170B in FIG. 1, or by a network-based device in conjunction with a user endpoint device. In one embodiment, the steps, functions, or operations of method 500 may be performed by a computing device or system 600, and/or processor 602 as described in connection with FIG. 6 below. For illustrative purpose, the method 500 is described in greater detail below in connection with an embodiment performed by a processor, such as processor 602. The method begins in step 502 and proceeds to step 510.

At step 510, the processor receives an image of an item of interest with location information and an offer to purchase the item of interest, e.g., from an endpoint device of a buyer. In one example, the item of interest is not an item that is currently offered for sale. In one example, the location information that is received may comprise the GPS coordinates of the mobile endpoint device when the image was taken. However, it should be noted that other types of coordinate information can be used, e.g., via triangulation using cell towers and the like. In one embodiment, the location information may include additional information, e.g., a current street address where the image was taken. Thus, in one embodiment, location information may comprise coordinate information and/or street address information.

At step 520, the processor attempts to identify the identity of the owner of the item of interest. For example, if the item of interest is a house, the processor, e.g., of AS 115, may consult with a database that contains a listing of real estate properties along with information associated with owners of such real estate properties. The location information will be instrumental in properly identifying the proper house. However, if the item of interest is a car, then the license plate of the car can be used to identify the owner in accordance with a database maintained by the department of motor vehicles. However, if the item of interest is a statue, then the location information is used to determine whether the location of the statue corresponds to a piece of artwork that is in the inventory of a municipality. If there is no match, then the location information is used to determine a business or a residential property that is located proximate to the statue. Contact information is obtained for such businesses or residential properties, e.g., phone numbers, email addresses and/or IP addresses. In one embodiment, since the network service provider also provides other network based services, the network service provider may have access to various databases that will allow the network service provider to identify the owner of the item of interest.

It should be noted that any access to any one or more of the above referenced databases is performed in accordance with the pertinent regulations. For example, publically available information will be the main sources that will be used to identify the owner of the item of interest. Additionally, certain private databases, e.g., operated by social networks, may be authorized by the users to allow their private information to be searched for the benefit of the users, e.g., some individuals may be willing to share their private information, e.g., ownership of a car or a boat to be made publically available for the purpose of receiving certain offers or benefits. In other words, some individuals may be willing to allow their private information to be used as part of a much larger big data analytics system. Such big data analytics system may be used as sources for identifying the owner of the item of interest. For example, an artist given permission by a city to showcase the artist's art works throughout the city, may be willing to disclose an inventory of the artist's art works (e.g., pictures of his or her art works) and their specific locations. Such disclosure of private information by the artist will bestow benefits to the artist and the public in general. Such listing may also assist the network service provider to identify the owner of the item of interest for the buyer. Once the owner or potential owner is identified, the method proceeds to step 530.

In step 530, the processor presents the buyer's offer to the owner of the item of interest, e.g., to an endpoint device of the owner. For example, if the item of interest is a house, then the offer of $300,000 from the buyer will be presented to the owner. For example, a notification message, e.g., an email, a text message, an automated phone message can be sent to the owner, e.g., a notification message may comprise:
“An unsolicited offer has been received from a buyer who wishes to purchase your house (item of interest) located at 123 Main Street, for the sum of $300,000. If you are the owner of the item of interest, please respond with: 1) whether the item of interest is for sale, 2) whether the offer is acceptable or not acceptable, and/or 3) whether additional information is required of the buyer (please specify what information is required).”

The above example notification message is only illustrative. In other words, any number of different formats of notification messages can be sent on behalf of the buyer.

At step 540, the processor determines whether an answer (broadly a response) responsive to the offer is received. If the query is answered negatively, the method 400 returns to step 540 and simply waits for a response. If the query is answered positively, the method 500 proceeds to step 550.

At step 550, the processor determines whether the answer indicates the item is for sale responsive to the offer. If the query is answered negatively, the method 500 ends in step 595. If the query is answered positively, the method 500 proceeds to step 560.

At step 560, the processor determines whether the offer is accepted. If the query is answered negatively, the method 500 proceeds to step 570. If the query is answered positively, the method 500 proceeds to step 565.

At step 565, the processor receives a request for buyer information to be presented to the seller to start the process of consummating the transaction. In other words, the buyer may have authorized the network service provider to reveal pertinent buyer privacy information (e.g., name of the number, address of the buyer, contact information of the buyer (e.g., a cellular phone number), credit card information of the buyer, pre-approved qualification of the buyer and so on), to the seller at some point during the negotiation process. In one embodiment, the identity and the privacy information of the buyer are not initially presented to the seller. This allows the initial negotiation to be conducted with a certain amount of anonymity of both the seller and the buyer. However, in certain situations, a seller may want more information to ensure that the negotiation is not conducted in vain, e.g., the seller may want the buyer to reveal certain privacy information early on before the negotiation is conducted. For example, a seller of a home may want to ensure that the unsolicited offer is a real offer and not a prank. As such, the seller may demand to have a verification that the buyer is prequalified for the amount of $300,000 as a mortgage loan before conducting any in depth negotiation with the buyer. As such, step 565 may occur much sooner and should not be limited as a step to be performed only after the offer is accepted. For example, step 565 may be implemented after step 550 once the item is deemed to be available for purchase.

At step 570, the processor determines whether a counter offer is received. For example, the response from the seller may be a simple no response without a counter offer in rejecting the offer or the response may further comprise a counter offer. If the seller does not want to make a counter offer, the method simply provides a negative response in step 575 to the buyer and method 500 ends in step 595 for now. If the seller does want to make a counter offer, the method proceeds to step 567, where a counter offer is received from the seller which will then be presented to the buyer and the method will also end in step 595 for now. It should be noted that although method 500 may end in “one cycle” of negotiation, if another counter offer or a new offer is received, then the negotiation will continue with the relevant portions of method 500 being executed again.

In one embodiment, the owner may be willing to list the item of interest for sale. In other words, once the owner has decided that the item of interest is indeed for sale now because the offer is received from the buyer, the owner may offer the item of interest to a number of potential buyers who will then bid for the item of interest. In one embodiment, the highest offer price for the item of interest will be provided to all interested buyers.

It should be noted that although not specifically specified, one or more steps, functions or operations of the methods 400 and 500 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIGS. 4 and 5 that recite a determining operation or involve a decision do not necessarily require that both branches of the determining operation be practiced. In other words, one of the branches of the determining operation can be deemed as an optional step. In addition, one or more steps, blocks, functions or operations of the above described methods 400 and 500 may comprise optional steps, or can be combined, separated, and/or performed in a different order from that described above, without departing from the example embodiments of the present disclosure.

As such, the present disclosure provides at least one advancement in the technical field of locating an owner of an item of interest. This advancement allows for a dedicated system to use a buyer's unsolicited offer as a mechanism to locate an owner of the item of interest. This ability allows the deployment of a service that assists a buyer to locate and present an offer for an item of interest that is currently not for sale to the proper owner. The present disclosure also provides a transformation of data. For example, an offer for purchase of an item of interest is transformed into a mechanism to seek out an owner of the item of interest and to act as an intermediary for both the buyer and the owner of the item of interest so that anonymity is maintained for both parties. The ability to maintain the anonymity for both parties is rooted in the use of the present service provided by the network service provider.

Finally, embodiments of the present disclosure improve the functioning of a computing device, e.g., a server and/or a user endpoint device. Namely, a server or endpoint device dedicated for providing transaction services is improved in being able to provide a transaction service for items that are initially not for sale.

FIG. 6 depicts a high-level block diagram of a computing device suitable for use in performing the functions described herein. As depicted in FIG. 6, the system 600 comprises one or more hardware processor elements 602 (e.g., a central processing unit (CPU), a microprocessor, or a multi-core processor), a memory 604 (e.g., random access memory (RAM) and/or read only memory (ROM)), a module 605 for locating the owner of an item on behalf of a user, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the methods 400 and 500 as discussed above are implemented in a distributed or parallel manner for a particular illustrative example, i.e., the steps of the above methods 400 and 500, or the entire method 400 or 500 can be implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed methods 400 and 500. In one embodiment, instructions and data for the present module or process 605 for locating the owner of an item on behalf of a user (e.g., a software program comprising computer-executable instructions) can be loaded into memory 604 and executed by hardware processor element 602 to implement the steps, functions or operations as discussed above in connection with the illustrative methods 400 and 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for locating the owner of an item on behalf of a user (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

It should be noted that “configuring” an electrical device may comprise the loading of instructions or machine readable codes onto the electrical device. Said another way, one or more electrical signals can be applied to the electrical device to configure the device to perform one or more described functions. Furthermore, it should be noted that “configuring” an electrical-mechanical device may comprise the loading of instructions or machine readable codes onto the electrical-mechanical device and/or implementing structural features (e.g., of appropriate size, shape and material) to bring about one or more described electrical and/or mechanical functions.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method comprising:
receiving, by a processor of a network service provider and over a communication network associated with the network service provider, from an endpoint device of a buyer, an offer for an item of interest that is not for sale;
receiving, by the processor, an image of the item of interest;
receiving, by the processor, location information associated with the item of interest;
determining, by the processor, an identity of an owner of the item of interest using the image and the location information;
sending, by the processor and over the communication network associated with the network service provider, the offer to an endpoint device of the owner of the item of interest;
receiving, by the processor and over the communication network associated with the network service provider, a response to the offer; and
sending, by the processor and over the communication network associated with the network service provider, the response to the endpoint device of the buyer.

2. The method of claim 1, wherein the location information comprises coordinate location information.

3. The method of claim 1, wherein the location information comprises street address information.

4. The method of claim 1, wherein the determining the identity further comprises using privacy information that is extracted from a user profile obtained from a social network.

5. The method of claim 1, wherein the item of interest is located on a residential property.

6. The method of claim 1, wherein the item of interest is located on a commercial property.

7. The method of claim 1, wherein the item of interest is located on a public property.

8. The method of claim 1, wherein the response indicates that the item of interest is not for sale.

9. The method of claim 1, wherein the response indicates that the offer is not accepted.

10. The method of claim 1, wherein the response indicates a counter offer.

11. The method of claim 1, wherein the item of interest comprises a house.

12. The method of claim 1, wherein the item of interest comprises a vehicle.

13. The method of claim 1, wherein the item of interest comprises an infrastructural item located in a public property.

14. The method of claim 1, wherein the item of interest comprises an advertising item located in a commercial property.

15. A non-transitory computer-readable storage medium storing instructions which, when executed by a processor of a network service provider, cause the processor to perform operations, the operations comprising:
receiving over a communication network associated with the network service provider, from an endpoint device of a buyer, an offer for an item of interest that is not for sale;
receiving an image of the item of interest;
receiving location information associated with the item of interest;
determining an identity of an owner of the item of interest using the image and the location information;
sending over the communication network associated with the network service provider, the offer to an endpoint device of the owner of the item of interest;
receiving over the communication network associated with the network service provider, a response to the offer; and
sending over the communication network associated with the network service provider, the response to the endpoint device of the buyer.

16. The non-transitory computer-readable storage medium of claim 15, wherein the location information comprises coordinate location information.

17. The non-transitory computer-readable storage medium of claim 15, wherein the location information comprises street address information.

18. The non-transitory computer-readable storage medium of claim 15, wherein the determining the identity further comprises using privacy information that is extracted from a user profile obtained from a social network.

19. The non-transitory computer-readable storage medium of claim 15, wherein the item of interest is located on a residential property, a commercial property, or a public property.

20. A device comprising:
a processor of a network service provider; and
a computer-readable medium storing instructions which, when executed by the processor, cause the processor to perform operations, the operations comprising:
receiving over a communication network associated with the network service provider, from an endpoint device of a buyer, an offer for an item of interest that is not for sale;
receiving an image of the item of interest;
receiving location information associated with the item of interest;
determining an identity of an owner of the item of interest using the image and the location information;
sending over the communication network associated with the network service provider, the offer to an endpoint device of the owner of the item of interest;
receiving over the communication network associated with the network service provider, a response to the offer; and
sending over the communication network associated with the network service provider, the response to the endpoint device of the buyer.
